(19) United States
(12) Patent Application Publication
(10) Pub. No.: US 2014/0327648 A1
(43) Pub. Date: Nov. 6, 2014

(54) Input Device, Control Unit and Method for Ascertaining a Position

(71) Applicant: Siemens Aktiengesellschaft, Muenchen (DE)

(72) Inventor: Paul Von Hase, Nurnberg (DE)

(73) Assignee: Siemens Aktiengesellschaft, Muenchen (DE)

(21) Appl. No.: 14/267,031

(22) Filed: May 1, 2014

(30) Foreign Application Priority Data
May 2, 2013 (EP) EP13166169

(51) Int. Cl. G06F 3/041

(52) U.S. Cl. CPC G06F 3/0414
USPC 345/174

(57) ABSTRACT

An input device includes a first electrically conductive surface and a second electrically conductive surface. The first and second surfaces are arranged at a distance from each other. The first surface is configured as an operating surface so that a pressure on a touch point deforms the first surface at the touch point such that the first surface and the second surface come into contact at the touch point and a current path is created over a part of the first surface to the touch point and from the touch point over a part of the second surface. The device also includes an analysis unit that is configured to measure a voltage value along the current path and to ascertain a position value from the voltage value. The device further includes a current-activation unit that is coupled to the first surface and configured to be synchronized with the analysis unit.

### FIELD OF INVENTION

The invention relates to an input device comprising a first electrically conductive surface and a second electrically conductive surface. The first and second electrically conductive surfaces are arranged at a distance from each other. The first electrically conductive surface is configured to be an operating surface such that when a pressure on a touch point deforms the first surface at the touch point the first surface and the second surface come into contact at the touch point, thereby allowing a position value to be determined.

The invention also relates to a control unit for analyzing a position of a touch point on an operating surface of an input device. The invention further relates to a method for ascertaining a position of a touch point on an operating surface of an input device.

### DESCRIPTION OF THE RELATED ART

The unexamined German application EP 1 770 480 A2 discloses an input device, a control unit and a method according to the combinations of features in the respective preambles of the independent patent claims of the EP application. In particular, a resistive touch sensor is considered as an input device in the context of the subject matter of the EP application, the subject matter being concerned with an existing weakness of resistive touch sensors. The weakness of the previously known resistive touch sensors is essentially due to a contact resistance and a capacitance between the two electrically conductive surfaces.

A simple resistive touch sensor comprises two electrically conductive surfaces that are electrically isolated. The two electrically conductive surfaces are separated from each other by a very small distance, and do not touch each other unless mechanical pressure is applied.

The rear surface preferably takes the form of a glass plate or plastic plate, while the front surface preferably consists of a polyester film. So-called spacers (tiny balls) are evenly disposed between the two surfaces, thereby preventing the film from touching the plate in the non-actuated state. Those sides of the plate and the film which face each other are preferably covered by an electrically conductive transparent ITO layer. If a sufficiently high pressure is exerted on the film, e.g. by a finger of a human hand or a stylus, the film touches the underlying plate in spite of the spacers. A more or less good electrically conductive contact between the two surfaces is produced at this location.

On the basis of an X-Y system of coordinates with an X-axis and a Y-axis, a fixed voltage is applied to the feed line assigned to an axis of the corresponding plate for the purpose of determining a position value of an axis. The resulting voltage potential is distributed according to Ohm's law between the plate ends receiving the voltage. The magnitude of the electric voltage at a specific point on the plate is, therefore, a measure of the one-dimensional position of the point on the axis of the plate. If a mechanical pressure is exerted on the outer plate (film), an electrical connection between the two surfaces is produced at this location. As a result of this connection, the surface to which no fixed voltage is applied is exchange charged to the potential, which the surface connected to the voltage source has, at precisely this touch point.

The surface which takes the potential is also referred to in the relevant art as a ‘wiper’, referring to the wiper of a potentiometer. The voltage which is present at the wiper therefore corresponds to the position on the corresponding coordinate axis.

Various electrical properties of a touch sensor have an interfering effect when determining the coordinate. The ohmic contact resistance which occurs when the two surfaces touch is a significant electrical property, wherein the contact resistance is also pressure-dependent. Furthermore, the two electrically conductive surfaces which form the touch sensor represent a capacitor. They therefore have a non-negligible capacitance relative to each other. Further properties include a capacitance of the circuit wiring, e.g. due to filtering, a capacitance of feed lines, and a capacitance of electronic components on a touch controller. These capacitances must be considered in combination as a total capacitance.

In order to improve a reliability of the measured coordinate values that are determined, provision is made in the prior art for a coordinate measurement to be carried out only if a supposedly sufficiently high pressure has been exerted on the touch sensor, for example. To this end, the contact resistance is measured (Z measurement) before and/or after the coordinate measurement. If this measured contact resistance is higher than a defined threshold, the measurement is not started or is discarded because the pressure was riot sufficient and, therefore, an incorrect measurement could occur.

However, this approach has two disadvantages. First, the measurement of the applied pressure does not take place at the same time as the coordinates are determined, but at best shortly before and/or shortly afterwards. In particular, the applied pressure of the operating object on the touch sensor changes very quickly when an operating object is dragged over the touch sensor. The measured values are therefore only partially valid for the time window during which the coordinates are determined. Secondly, the threshold must be set sufficiently high that a measured value can also be determined reliably. However, the higher the threshold is set, the more insensitive the touch sensor becomes, since it requires a higher applied pressure.

According to a further approach, the newly determined coordinate is compared with coordinate values from the recent past which, have already been classified as correct. The new value is only accepted if it lies plausibly in the sequence of previous values, otherwise it is discarded.

However, this approach has a significant problem. Since coordinate measurements are normally carried out in very quick succession, the other conditions between two measurements also hardly vary. The probability is, therefore, very high that successive incorrect measurements will lead to an incorrect yet similar result. Consequently, these results will be classified incorrectly as plausible and therefore as correct.

### SUMMARY OF THE INVENTION

An object of the invention is to improve the determination of measured values, in particular voltage values for ascertaining a position, and thereby to achieve greater reliability in the use of an input device.

The object is achieved by means of an input device that comprises a first electrically conductive surface and a second electrically conductive surface. The first and second electrically conductive surfaces are arranged at a distance from each other. The first electrically conductive surface is adapted as an operating surface and is so configured that a pressure on a touch point deforms the first surface at the touch point such that the first surface and the second surface come into contact at the touch point and a current path is created over a part of the first surface to the touch point and from the touch point over a part of the second surface. The input device also comprises an analysis unit which is adapted to measure a voltage value along the current path and to ascertain a position value therefrom. The input device further comprises a current-activation means, or unit, which is connected to the first surface. The analysis unit and the current-activation unit are configured to be synchronized with each other in relation to a time point of a voltage value measurement of the analysis unit. The current-activation unit is also adapted to impress a current into the first surface before the time point of a voltage value measurement, in order to exchange charge the first surface from a first electric potential to a second electric potential.

By virtue of the present invention, position values can be correctly determined without the sensitivity of the input device, e.g. the ease of use of a touch sensor, being adversely affected by the interference immunity that is associated with the correct determination. Unlike, and contrary to, the prior art, in which an increase in touch sensor sensitivity while preserving interference immunity requires that a measurement is only carried out or performed if the contact resistance measurement is less than a threshold value, suggesting a sufficiently high applied pressure, the present invention no longer requires a determination of the applied pressure.

The analysis unit could determine a voltage value which corresponds to the position on the basis of a pressure on the operating surface, but the first surface is exchange charged by the current-activation unit and the current impressed thereby, from the present electric potential to a second electric potential, before the voltage value is measured. The voltage value is therefore initially deliberately “pulled away” from its true value by the current-activation unit. After a dine delay, which allows the surface to exchange charge back to the correct electric potential, the measurement of the voltage value takes place. This means that the current is first impressed, whereby the surface is precharged to an incorrect Value. However, a time period is then allowed to elapse in order to give the surface an opportunity to exchange charge back to the correct value. In order to increase the interference immunity, the analysis unit is advantageously configured to measure a first voltage value and a second voltage value for the voltage value, and to check the results of the two voltage values in respect of their agreement.

In a further embodiment of the input device, the current-activation unit is adapted to impress the current into the first surface for a first time period before the time point of the measurement of the first voltage value and to deactivate the current again after the first time period has elapsed. In this case the analysis unit is adapted to carry out the first measurement of the first voltage value after a second time period has elapsed, and the current-activation means is also adapted to impress a current into the first surface again for a third time period after the first measurement, in order to exchange charge the first surface again from its present potential to another potential. In this case the analysis unit is further adapted to carry out the measurement of the second voltage value after a fourth time period has elapsed.

The results of at least two measurements are checked for agreement in the methods known in the art, but consecutive incorrect measurements can give very similar measurement results in the context of the existing prior art, and therefore these are difficult if not impossible to recognize as incorrect. According to the invention, however, consecutive incorrect measurements differ markedly from each other. Incorrect measurements can, therefore, be unambiguously identified as such. This advantage is achieved by deliberately precharging the first electrically conductive surface and the resulting total capacitance before each measurement, preferably via a current-restricted source, to a potential which differs from the correct measured value. The precharging of the surface does not always occur in the direction of the same potential in this case, there being instead at least two different potentials in whose direction the current-restricted source can exchange charge the surface or the total capacitance.

In the case of consecutive measurements of the same coordinate axis, an effective variant with regard to interference immunity when ascertaining, the position value comprises precharging the first surface alternately in the direction of one then the other potential. This allows one measurement to be carried out starting from a lower potential and the following measurement from a higher potential.

The current-activation means, or unit, advantageously has a current-restricted source and a switching means. The current-activation unit can be regulated and is adapted to reverse the direction of or adapt the current in relation to an exchange charge current, in order to achieve the respective exchange charging of the first surface from its present potential to another potential.

The current-activation unit is advantageously configured to have a lower and an upper limit of adjustment, the limits corresponding respectively to at least the lowest and the highest voltage values that are to be determined. The limits of adjustment of the source therefore preferably correspond to at least the highest and the lowest theoretical measured value, signifying the largest and the smallest coordinate.

With regard to the input device, it is also advantageous for the analysis unit to be further adapted to compare the first voltage value with the second voltage value, and to discard the measurement as invalid if the two voltage values differ by a predefinable extent from each other.

In the event that the voltage value of the wiper plate disadvantageously drifts away when the pressure on the first surface is too low during the exchange charge time delay, e.g. due to leakage currents, the exchange charge process can be modified as follows. The current-activation unit is configured in such a way that it is not switched off completely during the second time period, but provides a current which counteracts an incorrect measurement brought about by leakage currents in the device, the current being at least equal to the absolute value of the leakage current in particular, thereby allowing incorrect measurements to be reliably recognized again.

In one embodiment, the input device is configured such that the first electrically conductive surface has a first connection interface and a second connection interface, the first and second electrically conductive surfaces being arranged opposite to each other, and the second electrically conductive surface has a third connection interface and a fourth connection interface, the third and fourth connection interfaces being arranged opposite to each other. This arrangement corresponds to a 4-wire touch. However, the invention can be applied equally well to a 5-wire to 8-wire touch.

The object cited in the introduction is also achieved by a control unit for analyzing a position of a touch point on an operating surface of an input device. For this purpose, the input device has a first electrically conductive surface and a second electrically conductive surface, the first and second electrically conductive surfaces being arranged at a distance from each other. The first electrically conductive surface is adapted as the operating surface and is configured so that a pressure on the touch point deforms the first surface at the touch point such that the first surface and the second surface come into contact at the touch point and a current path is created over a part of the first surface to the touch point and from the touch point over a part of the second surface. The control unit also comprises an analysis unit which is adapted to measure a voltage value along the current path and to ascertain a position value therefrom.

When capturing measured values, greater interference immunity can be achieved because the control unit, which can also be considered as a touch controller, has a current-activation means, or unit, in addition to the analysis unit, and the current-activation unit and the analysis unit are adapted to be synchronized with each other in relation to a time point of a voltage value measurement of the analysis unit. The current-activation unit is adapted to provide a current for the first surface before the time point of a voltage value measurement, in order to exchange charge the first surface from a first electric potential to a second electric potential. The analysis unit of the control unit is adapted to measure a first voltage value and a second voltage value for the voltage value, and to check the results of the two voltage values in respect of their agreement.

When analyzing a first voltage value and a second voltage value, the control unit with an additional current-activation unit is configured to impress the current into the first surface for a first time period before the time point of the measurement of the first voltage value and to deactivate the current again after the first time period has elapsed. In this case the analysis unit is configured to carry out the first measurement of the first voltage value after a second time period has elapsed, and the current-activation unit is configured to impress a current into the first surface again for a third time period after the first measurement, in order to exchange charge the first surface again from its present potential to another potential. In this case the analysis unit is configured to carry out the measurement of the second voltage value after a fourth time period has elapsed.

In one embodiment, the control unit provides for precharging the first surface alternately in the direction of one then the other potential in the case of consecutive measurements of the same coordinate axis. This means that the first measurement can be carried out starting from a lower potential, for example, and the subsequent, second measurement from a higher potential.

A measurement could, therefore, comprise the following sequence: the first surface is precharged for a given duration via a current-restricted source in the direction of a first limit of adjustment. The current-restricted source is deactivated, e.g. switched to high impedance. A given time period is then allowed to elapse again, in order that the first surface can exchange charge via the contact resistance to the potential which corresponds to the coordinate of the touch point. Finally, the associated voltage value is determined. The subsequent, second measurement follows the same sequence, wherein this time the current-restricted source precharges the first surface in the direction of the other limit of adjustment.

The current-activation unit of the control unit can be regulated for this purpose, and is adapted to reverse the direction of or adapt the current in relation to an exchange charge current, in order to achieve the respective exchange charging of the first surface from its present potential to another potential.

The current-activation means is advantageously adapted to have a lower and an upper limit of adjustment, the limits corresponding respectively to at least the lowest and the highest voltage values that are to be determined.

The control unit can be considered as a touch controller which is in the form of an integrated circuit or a printed circuit board, wherein the analysis unit of this control unit is adapted to compare the first voltage value with the second voltage value, and to discard the measurement as invalid if the two voltage values differ by a predefinable extent from each other.

Furthermore, the current-activation unit in the control unit is preferably adapted in such a way that it is not switched off completely during the second time period, but provides a current which counteracts an incorrect measurement brought about by leakage currents in the device.

The object cited in the introduction is also achieved by a method for ascertaining a position of a touch point on an operating surface of an input device. The method is applied to an input device having a first electrically conductive surface and a second electrically conductive surface, the first and second electrically conductive surfaces being arranged at a distance from each other. In this case, the first electrically conductive surface is adapted as an operating surface and is so configured so that a pressure on a touch point deforms the first surface at the touch point such that the first surface and the second surface come into contact at the touch point and a current path is created over a part of the first surface to the touch point and from the touch point over a part of the second surface, wherein a voltage value along the current path is measured and a position value is ascertained therefrom using an analysis unit.

In order to increase an interference resistance when determining measured values in the context of this method, a current-activation unit which is connected to the first surface is also used to impress a current into the first surface in order to exchange charge the first surface from a first electric potential to a second electric potential, wherein the analysis unit and the current-activation unit are synchronized with each other in such a way that the current-activation unit activates the current to the first surface before a time point of a voltage value measurement of the analysis unit. In this case, the analysis unit advantageously measures a first voltage value and a second voltage value and checks the results of the two voltage values in respect of their agreement.

An increased interference resistance is achieved if the current-activation unit impresses the current into the first surface for a first time period before the time point of the measurement of the first voltage value and deactivates the current again after the first time period has elapsed. In this case the analysis unit is operated in such a way that the first measurement of the first voltage value is carried out after a second time period has elapsed, and after the first measurement a current is again impressed into the first surface for a third time period by the current-activation unit in order to exchange charge the first surface again from its present potential to another potential, and the measurement of the second voltage value is carried out after a fourth time period has elapsed.

It is considered a decisive advantage of the method that the first surface is deliberately precharged to an “incorrect” value before a measurement. In contrast with solutions according to the prior art, however, at least two different potentials are available for this purpose, such that the first surface is precharged both above and below the correct or possible voltage value to be determined. Consequently, the possible measurement error is positive in one case and negative in another case. If two measured values determined in quick succession are now deducted one from the other, the remainder represents the sum of the measurement errors. It is therefore possible to decide immediately whether the accuracy of the measurement (position value) is sufficient or whether the measurement must be repeated. In contrast with the variants disclosed in the prior art, a pressure measurement (Z measurement) can be omitted in the variant according to the invention, thereby increasing the sensitivity of the operating surface or touch sensor.

### BRIEF DESCRIPTION OF THE DRAWINGS

In order to explain the invention in greater detail, the drawing shows an exemplary embodiment in which:

FIG. 1 shows a schematic illustration of an input device which comprises an analysis unit and a touch sensor comprising a first and a second electrically conductive surface in accordance with one embodiment of the invention,

FIG. 2 shows a diagram of charge curves resulting from different applied pressures in accordance with one embodiment of the invention,

FIG. 3 shows a diagram of charge curves resulting from similar applied pressure in accordance with one embodiment of the invention, and

FIG. 4 shows a temporal measurement sequence for the start of a first measurement, the corresponding time delays and the subsequent start of a second measurement in accordance with one embodiment of the invention.

### DETAILED DESCRIPTION OF THE PREFERRED EMBODIMENTS

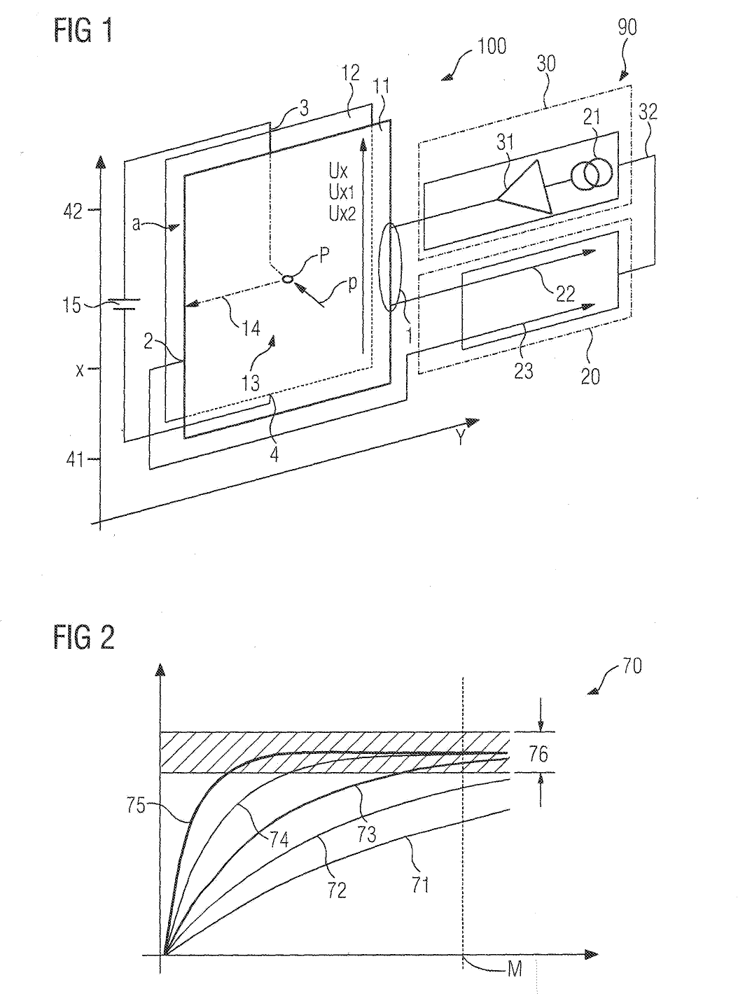

FIG. 1 shows a schematic illustration of an input device 100 in accordance with one embodiment of the invention. The input device 100 comprises an operating surface 13 which can be touched by an operating object, e.g., a finger of a human hand, wherein an analysis unit 20 connected to the operating surface 13 can determine a position value X of a touch point P from a voltage value measurement.

Such input devices are used, e.g., as touch sensors in front of an LCD display of an operating panel. The operating panel, which therefore features a touch screen, can for example be used to control industrial processes using automation devices. The operating surface 13 has a first electrically conductive surface 11 comprising a first connection interface 1 and a second connection interface 2, the first and second connection interfaces 1 and 2 being arranged opposite to each other. Behind the first electrically conductive surface 11 is a second electrically conductive surface 12 comprising a third connection interface 3 and a fourth connection interface 4, the third and fourth connection interfaces 3 and 4 being arranged opposite to each other. A resistive touch sensor is realized by virtue of this superimposed arrangement of the two electrically conductive surfaces 11 and 12. In this case, the electrically conductive surfaces 11 and 12 are arranged at a distance ‘a’ from each other. The distance ensures that the first surface 11 is electrically isolated from the second surface 12 when no mechanical pressure is exerted on the first surface 11.

The rear surface, i.e., the second electrically conductive surface 12, is usually realized in the form of a glass plate or plastic plate, while the upper surface, i.e., the first electrically conductive surface 11 comprises a polyester film. So-called spacers are evenly disposed between the two plates or between the two surfaces to prevent the two surfaces or plates from touching each other in a non-actuated state.

The first electrically conductive surface 11 is therefore so embodied that a pressure ‘p’ at the touch point P deforms the first surface 11 at the touch point P in such a way that the first surface 11 and the second surface 12 come into contact at the touch point P and a current path 14 is created from the third connection interface 3 via a part of the second surface 12 to the touch point P and from the touch point P via a part of the first surface 11 to a second connection interface 2.

A voltage is supplied to the second surface 12 via a voltage source 15, which is connected to both the third connection interface 3 and the fourth connection interface 4 of the second surface 12. By virtue of the voltage of the voltage source 15, a voltage potential is produced between the third connection interface 3 and the fourth connection interface 4, and is distributed evenly between the third connection interface 3 and the fourth connection interface 4 according to Ohm's law. The magnitude of the electric voltage at a specific point P on the plate is therefore a measure of the one-dimensional position of the point P on an axis of the plate. If a mechanical pressure p is exerted on the outer surface (film), an electrical connection between the two surfaces 11 and 12 is produced at this location.

In the case of a touch sensor, provision is normally made for sampling the position values x of an X-axis X and y of a Y-axis Y. The corresponding system of coordinates is indicated below the input device 100. The capture of a coordinate x of the X-axis X is explained below with reference to the exemplary input device 100 shown in FIG. 1. Capture of the further y coordinate of the Y-axis Y is carried out analogously.

The analysis unit 20 is adapted to measure the voltage value Uₓ along the current path 14, and to ascertain the position value x therefrom. In this case, the analysis unit 20 is adapted to measure a first voltage value Uₓ₁ and a second voltage value Uₓ₂ for the voltage value Uₓ, and to compare the results of the two voltage values Uₓ₁ and Uₓ2 in respect of their agreement.

A first measurement line 22 and a second measurement line 23 lead to the analysis unit 20. The first measurement line 22 is connected to the first connection interface 1 and the second measurement line 23 is connected to the second connection interface 2.

In order to improve reliability when determining the measured values, the input devices according to the prior art measure a contact resistance (Z measurement) before and/or after a coordinate measurement. If the measured contact resistance exceeds a defined threshold, the measurement is discarded or not even started. Using the device and/or the method according to the invention, however, it is no longer necessary to carry out a Z measurement, yet the reliability of the determined measured values is nonetheless increased.

To this end, a control unit 90 comprises a current-activation unit, 30 in addition to the analysis unit 20. The analysis unit 20 and the current-activation unit 30 are adapted to be synchronized with each other in relation to a time point of a voltage value measurement of the analysis unit 20. A synchronization line 32 connects the analysis unit 20 to the current-activation unit 30 for the synchronization. In this case, the current-activation unit 30 is adapted to impress a current into the first surface 11 before the time point of a voltage value measurement, in order to exchange charge the first surface 11 from a first electric potential P₀ to a second electric potential P₁.

The current-activation unit 30 has a current source 21 and a switching device 31, which are connected in series to the first connection interface 1. Before the measurement of the first voltage value Uₓ₁, a current is impressed at the first connection interface 1 by the switching device 31 for a first time period T₁ (see FIG. 4). The current-activation unit 30 is also adapted to deactivate the current again after the first time period T₁ has elapsed, and in this case the analysis unit 20 is adapted to carry out the first measurement of the first voltage value Uₓ₁ after a second time period TW₁ has elapsed, and the current-activation unit 30 is adapted to impress a current into the first surface 11 again for a third time period T₂ after the first measurement, in order to exchange charge the first surface 11 again from its present potential P₀ to another potential P₂, and in this case the analysis unit 20 is adapted to carry out the measurement of the second voltage value Uₓ₂ after a fourth time period TW₂ has elapsed.

The captured first voltage value Uₓ₁ and the captured second voltage value Uₓ₂ are now stored in the analysis unit 20, the analysis unit 20 being adapted to check the first voltage value Uₓ₁ and the second voltage value Uₓ₂ in respect of their agreement for the voltage value Uₓ.

When determining the coordinate x of the touch point P, the ohmic contact resistance between the first surface 11 and the second surface 12 and a capacitance of the two surfaces 11 and 12 relative to each other may have an interfering effect. Further interference may be caused by a capacitance of the circuit wiring of the input device 100, e.g., due to filtering. These capacitances must be combined to form a total capacitance. The total capacitance delays a measurement since it must be exchange charged. The contact resistance is pressure-dependent.

FIG. 2 shows a diagram 70 of charge curves resulting from different applied pressures. For the purpose of explanation, five successive exchange-charge curves are illustrated using a first voltage profile 71, a second voltage profile 72, a third voltage profile 73, a fourth voltage profile 74 and a fifth voltage profile 75. The voltage profiles 71, 72, 73, 74, and 75 could be produced by different applied pressures p at a touch point P.

The measurement of the voltage value Uₓ is performed at a measurement time point M (broken line) in each case. If a region 76 is considered to represent an acceptable measurement, the first voltage profile 71 and the second voltage profile 72 lead to an inaccurate measurement, and hence an incorrect measurement. This means that the applied pressure p was not sufficiently high for an accurate measurement in the case of the first voltage profile 71 and the second voltage profile 72. The third voltage profile 73 and the fourth voltage profile 74 do enter the region 76 for an acceptable measurement, but reach the region 76 later than in the case of the desired fifth voltage profile 75.

The contact resistance between the first surface 11 and the second surface 12 is not only dependent on the applied pressure p, but is also influenced by the fact that contact interruptions can occur at any time as a result of dragging the operating object over the operating surface 13, i.e., over the touch sensor, even if the pressure is held constant.

One reason for this is the spacers. If the pressure p is exerted at precisely a location of the first surface 11 below which a spacer is situated, this spacer will absorb a large portion of the pressure p. The first surface 11 therefore touches the second surface 12 with less force at this location, whereby the contact resistance between the first surface 11 and the second surface 12 increases significantly. It may also be the case that the electrical connection above the contact resistance at the touch point P is interrupted completely. With regard to the voltage profiles illustrated in FIG. 2, this means that a voltage dip can occur in the voltage profiles, during which no further voltage increase can he recognized for a given time.

The high-impedance contacts or interruptions caused by the spacers significantly prolong an exchange charge time of the total capacitance. Consequently, the voltage for the total capacitance has not yet built up at a predefined measurement time point M, and an incorrect measurement is received despite a supposedly high applied pressure.

In order now to improve the reliability of the measured values, the first electrically conductive surface 11 (and the resulting capacitances) is deliberately precharged via the current-restricted source 21, before each measurement, to a potential which differs from the correct future measured value.

The precharging of the first surface 11 does not always take place in the direction of the same potential in this case, there being instead at least two different potentials, namely (starting from a first potential P₀) a second potential P₁ and a third potential P₂, in whose direction the current-restricted source 21 exchange charges the first surface 11.

In this case, the current-restricted source 21 is adapted such that it can be regulated and, in relation to the second potential P₁ and/or the third potential P₂ to be achieved, can impress opposite currents into the first surface 11.

The limits of adjustment of the current-restricted source 21 should ideally be selectable above and below the “correct” measured value. This requirement is most easily satisfied if the limits of adjustment of the current-restricted source 21 correspond at least to the highest and the lowest theoretically possible measured value, corresponding to a lowest position value 41 (see FIG. 1) and a highest position value 42 (see FIG. 1).

The selection of the potential to which the first surface 11 is to be precharged before a measurement can follow different strategies. An effective selection in the case of consecutive measurements on the same coordinate axis is to precharge the first surface 11 alternately in the direction of one then the other potential. This allows the first measurement to be carried out starting from, e.g., a low potential and the subsequent, second measurement to be carried out starting from, e.g., a higher potential.

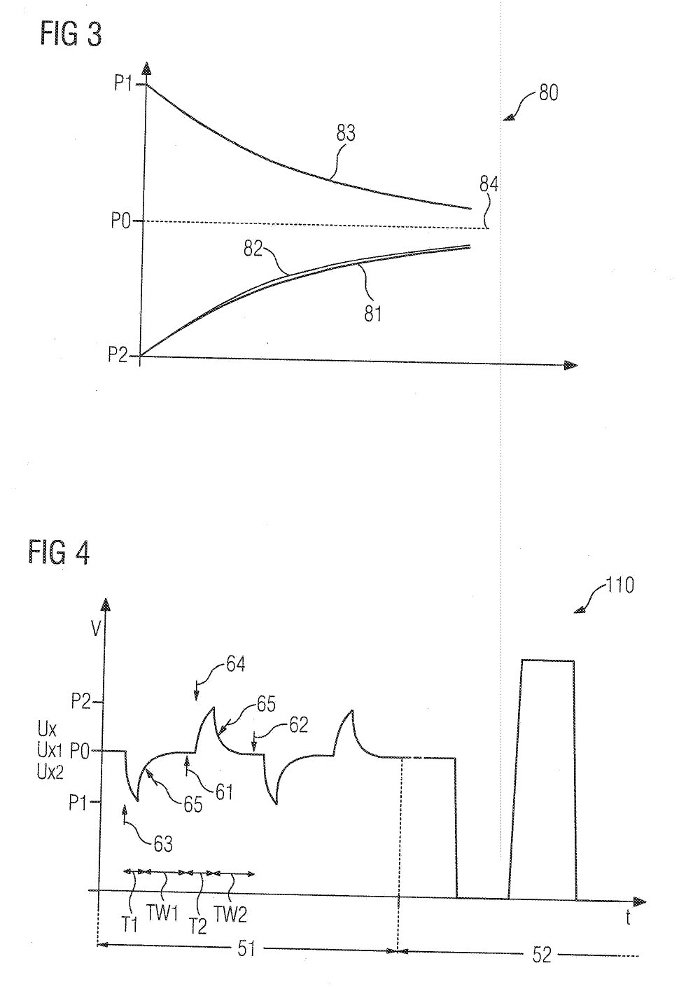

The principle of the first measurement from a low potential and the next measurement from a higher potential, specifically the second potential P₁ and the third potential P₂, respectively, is explained in greater detail with reference to FIG. 3. FIG. 3 shows a diagram 80 which illustrates charge curves resulting from a similar applied pressure p. The first exchange charge curve 81, the second exchange charge curve 82 and the third exchange charge curve 83 are shown for the purpose of illustrating a target value 84. For all three exchange charge curves 81, 82, and 83, it is assumed that the applied pressure is so low in all three cases that the first surface 11 does not reach the target value 84 at the touch point P in respect of its voltage value which must be measured in order to ascertain a position of the position value x.

Both the first exchange charge curve 81 and the second exchange charge curve 82 start from the same potential, and therefore barely differ from each other as a result of the similarly applied pressure. The endpoint is likewise almost identical for both. In a comparison of the two curve profiles, it is not apparent whether both are incorrect or how great the error may be. On the contrary, the high degree of similarity of the two curve profiles suggests an accurate measurement. The determined value is actually too low, however.

By contrast, the third exchange charge curve 83 starts from a higher potential above the unknown correct target value 84. Since the applied pressure was again insufficient in the case of this measurement, i.e., in the case of the third exchange charge curve 83, the target value is not reached here either. The distance from the target value is just as great as in the case of the first exchange charge curve 81 and the second exchange charge curve 82. However, since the process was started from “above,” the determined measured value lies above rather than below the target value 84.

The measured value which is determined using the third exchange charge curve 83 differs significantly from those measured values which were determined using the first exchange charge curve 81 or the second exchange charge curve 82. It is, therefore, established beyond doubt that at least one measurement must have returned an incorrect result.

The following findings can be derived from the two different measured values: (a) The correct value must lie between the final value of the upper curve and that of the lower curve; (b) The maximal measurement error of an individual measurement is the difference between the two measured values; (c) If the two final values are averaged together, the maximal measurement error is half of the difference between the two measured values.

FIG. 4 shows a possible measurement sequence 110. A possible voltage profile of the voltage values Uₓ₁ and Uₓ₂ is illustrated over the time ‘t.’ A first region 51 represents a temporal region during which a pressure p is exerted at the touch point P. The subsequent, second region 52 represents a temporal region during which the operating surface 13 is not actuated.

The voltage profile drops when the current-activation unit 30 starts 63 to impress the current, wherein the current to the first surface 11 remains activated via the switching device 31 for a first time period T₁. After the first time period T₁ has elapsed, the current is deactivated by the switching device 31 and a second time period TW₁ is started. During this second time period TW₁, the total capacitance of the arrangement can exchange charge in the direction of the target value again. An exchange charge process 65 therefore takes place. When the second time period TW₁ has elapsed, the total capacitance has sufficiently exchange charged for a subsequent measurement, and the first voltage value Uₓ₁ can be determined at a first measurement time point 61. Following thereupon, the start 64 of the activation of the current with sign reversal commences. The current enters an exchange charge process 65 in the direction of the target value, and the current has been activated for a third time period T₂. When the third time period T₂ has elapsed, a fourth time period TW₂ is started. When the fourth time period TW₂ has also elapsed, the second voltage U₂ is determined at a second measurement time point 62.

As an alternative to the approach described above, in which provision is made for continuously switching alternately between the potentials P₁ and P₂ above and below the possible and/or correct measured value, a further strategy can also he applied to the precharging of the first surface 11. For this purpose, unlike the first strategy, no provision is made for switching in strict alternation between the potentials P₁ and P₂ above and below the possible measured value, however, and the first surface is instead precharged before each measurement in the direction of that potential which lies further away from the most recently captured measured value.

As a result of the total capacitance always being exchange charged in the direction of a distant potential by the precharging, a correspondingly high potential must be bridged again during the subsequent exchange charge process via the contact resistance. This makes it less probable that consecutive incorrect measurements will return a similar measured value in each case and be interpreted as correct.

The series of detailed descriptions set forth above are only specific descriptions directed to the feasible embodiments of the present invention, and are not intended to limit the scope of protection of the present invention; and all the equivalent embodiments or modifications made without departing from the technical spirit of the present invention shall he included in the scope of protection of the present invention.

What is claimed is:

1. An input device comprising:
a first electrically conductive surface and a second electrically conductive surface that are arranged at a distance from each other, wherein the first electrically conductive surface is configured as an operating surface so that a pressure on a touch point deforms the first electrically conductive surface at the touch point such that the first electrically conductive surface and the second electrically conductive surface come into contact at the touch point and a current path is created over a part of the first electrically conductive surface to the touch point and from the touch point over a part of the second electrically conductive surface;
an analysis unit configured to measure a voltage value along the current path and to ascertain a position value from the voltage value; and
a current-activation unit coupled to the first electrically conductive surface and configured to be synchronized with the analysis unit in relation to a time point of a voltage value measurement of the analysis unit, wherein the current-activation unit is further configured to impress a current into the first electrically conductive surface before the time point of the voltage value measurement to exchange charge the first electrically conductive surface from a first electric potential to a second electric potential.

2. The input device of claim 1, wherein the analysis unit is further configured to measure a first voltage value and a second voltage value for the voltage value and to check the results of the first and second voltage values in respect of their agreement.

3. The input device of claim 2,
wherein the current-activation unit is further configured to impress the current into the first electrically conductive surface for a first time period before the time point of the measurement of the first voltage value and to deactivate the current again after the first time period has elapsed,
wherein the analysis unit is further configured to carry out the first measurement of the first voltage value after a second time period has elapsed,
wherein the current-activation unit is further configured to impress a current into the first electrically conductive surface again for a third time period after the first measurement in order to exchange charge the first electrically conductive surface again from a present potential to another potential, and
wherein the analysis unit is further configured to carry out the measurement of the second voltage value after a fourth time period has elapsed.

4. The input device of claim 2, wherein the analysis unit is further configured to compare the first voltage value with the second voltage value and to discard the measurement as invalid if the first and second voltage values differ by a predefinable extent from each other.

5. The input device of claim 2, wherein the current-activation unit is further configured such that the current-activation unit is not switched off completely during the second time period to provide a current which counteracts an incorrect measurement brought about by leakage currents in the input device.

6. The input device of claim 1, wherein the current-activation unit is further configured to have a lower and an upper limit of adjustment, wherein the lower and upper limits correspond respectively to at least the lowest and the highest voltage values that are to be determined.

7. The input device of claim 1, wherein the current-activation unit has a current-restricted source and a switching device.

8. The input device of claim 1, wherein the current-activation unit is regulated and is further configured to reverse the direction of or adapt the current in relation to an exchange charge current in order to achieve the respective exchange charging of the first electrically conductive surface from a present potential to another potential.

9. The input device of claim 1, wherein the first electrically conductive surface has a first connection interface and a second connection interface that are arranged opposite to each other, and wherein the second electrically conductive surface has a third connection interface and a fourth connection interface that are arranged opposite to each other.

10. A control unit for analyzing a position of a touch point on an operating surface of an input device, wherein the input device has a first electrically conductive surface and a second electrically conductive surface that are arranged at a distance from each other, and wherein the first electrically conductive surface is configured as an operating surface and also configured so that a pressure on a touch point deforms the first electrically conductive surface at the touch point such that the first electrically conductive surface and the second electrically conductive surface come into contact at the touch point and a current path is created over a part of the first electrically conductive surface to the touch point and from the touch point over a part of the second electrically conductive surface, the control unit comprises:
an analysis unit configured to measure a voltage value along the current path and to ascertain a position value from the voltage value; and
a current-activation unit configured to be synchronized with the analysis unit in relation to a time point of a voltage value measurement of the analysis unit and to provide a current for the first electrically conductive surface before the time point of the voltage value measurement in order to exchange charge the first electrically conductive surface from a first electric potential to a second electric potential.

11. The control unit of claim 10, wherein the analysis unit is further configured to measure a first voltage value and a second voltage value for the voltage value and to check the results of the first and second voltage values in respect of their agreement.

12. The control unit of claim 11,
wherein the current-activation unit is further configured to impress the current into the first electrically conductive surface for a first time period before the time point of the measurement of the first voltage value and to deactivate the current again after the first time period has elapsed,
wherein the analysis unit is further configured to carry out the first measurement of the first voltage value after a second time period has elapsed,
wherein the current-activation unit is further configured to impress a current into the first electrically conductive surface again for a third time period after the first measurement in order to exchange charge the first electrically conductive surface again from a present potential to another potential, and
wherein the analysis unit is further configured to carry out the measurement of the second voltage value after a fourth time period has elapsed.

13. The control unit of claim 11, wherein the current-activation unit has a current-restricted source and a switching device.

14. The control unit of claim 11, wherein the current-activation unit is regulated and is configured to reverse the direction of or adapt the current in relation to an exchange charge current in order to achieve the respective exchange charging of the first electrically conductive surface from a present potential to another potential.

15. The control unit of claim 11, wherein the current-activation unit is further configured to have a lower and an upper limit of adjustment, wherein the lower and upper limits correspond respectively to at least the lowest and the highest voltage values that are to be determined.

16. The control unit of claim 11, wherein the current-activation unit is further configured that the current-activation unit is not switched off completely during the second time period to provide a current which counteracts an incorrect measurement brought about by leakage currents in the device.

17. The control unit of claim 10, wherein the analysis unit is further configured to compare the first voltage value with the second voltage value and to discard the measurement as invalid if the first and second voltage values differ by a predefinable extent from each other from a limit value.

18. A method for ascertaining a position of a touch point on an operating surface of an input device, wherein the input device includes an analysis unit, a current-activation unit and a first and second electrically conductive surfaces that are arranged at a distance from each other, the method comprising:
causing the first electrically conductive surface to be configured as an operating surface so that a pressure on a touch point deforms the first electrically conductive surface at the touch point such that the first electrically conductive surface and the second electrically conductive surface come into contact at the touch point and a current path is created over a part of the first electrically conductive surface to the touch point and from the touch point over a part of the second electrically conductive surface,
causing the current-activation unit to impress a current into the first electrically conductive surface to exchange charge the first electrically conductive surface from a first electric potential to a second electric potential, wherein the current-activation unit is coupled to the first electrically conductive surface;
causing the analysis unit and the current-activation unit to be synchronized with each other in such a way that the current-activation unit activates the current to the first electrically conductive surface before a time point of a voltage value measurement of the analysis unit; and
causing the analysis unit to measure a voltage value along, the current path to ascertain a position value based on the measured voltage value.

19. The method of claim 18, causing the analysis unit to measure the voltage value comprises causing the analysis unit to measure a first voltage value and a second voltage value and check the results of the first and second voltage values in respect of their agreement.

20. The method of claim 19,
wherein causing the current-activation unit to impress the current into the first electrically conductive surface comprises causing the current-activation unit to impress the current into the first electrically conductive surface for a first time period before the time point of the measurement of the first voltage value and deactivates the current again after the first time period has elapsed, and
wherein the analysis unit and the current-activation unit is caused to be synchronized with each other such that the analysis unit is operated in such a way that the first measurement of the first voltage value is carried out after a second time period has elapsed, and after the first measurement a current is again impressed into the first electrically conductive surface for a third time period by the current-activation unit in order to exchange charge the first electrically conductive surface again from a present potential to another potential and the measurement of the second voltage value is carried out after a fourth time period has elapsed.
